(19) United States
(12) Patent Application Publication
(10) Pub. No.: US 2017/0344542 A1
(43) Pub. Date: Nov. 30, 2017

(54) INFORMATION QUERY METHOD, TERMINAL DEVICE, SYSTEM AND COMPUTER STORAGE MEDIUM

(71) Applicant: Tencent Technology (Shenzhen) Company Limited, Shenzhen (CN)

(72) Inventor: Hongtao Zuo, Shenzhen (CN)

(21) Appl. No.: 15/625,716

(22) Filed: Jun. 16, 2017

Related U.S. Application Data
(63) Continuation of application No. PCT/CN2016/081193, filed on May 5, 2016.

(30) Foreign Application Priority Data
Jun. 5, 2015 (CN) 201510303236.7

(51) Int. Cl. G06F 17/30

(52) U.S. Cl. CPC G06F 17/30026; G06F 17/30029; G06F 17/3005

(57) ABSTRACT

The present application discloses an information query method, a terminal device, a system, and a computer storage medium. The method includes: collecting multimedia information using the terminal device; performing feature extraction on the multimedia information from at least one feature dimension, to obtain at least one feature parameter corresponding to the multimedia information in each of the feature dimensions; performing querying in a corresponding feature dimension based on the at least one extracted feature parameter to obtain a corresponding query result in the at least one feature dimension by submitting a search request including information of the at least one extracted feature parameter to the server, wherein the server is configured to generate the corresponding query result from the information database using the at least one feature parameter and return the corresponding query result to the terminal device; and receiving and displaying the corresponding query result using the terminal device.

### PRIORITY CLAIM AND RELATED APPLICATION

This application is a continuation application of PCT Patent Application No. PCT/CN2016/081193, entitled “INFORMATION QUERY METHOD, TERMINAL DEVICE, SYSTEM, AND COMPUTER STORAGE MEDIUM” filed on May 5, 2016, which claims priority to Chinese Patent Application No. 201510303236.7, entitled “INFORMATION QUERY METHOD, TERMINAL DEVICE, SYSTEM, AND COMPUTER STORAGE MEDIUM” filed on Jun. 5, 2015, both of which are incorporated by reference in their entirety.

### FIELD OF THE TECHNOLOGY

The present disclosure relates to terminal processing technologies of the information processing field, and in particular, to an information query method, a terminal device, a system, and a computer storage medium.

### BACKGROUND OF THE DISCLOSURE

Currently, with deeper involvement of terminal devices, especially smart devices, in people's daily life, the terminal devices also bring more convenience to people. However, generally a user needs to know a name of a target and can then perform searching by using a search site or software when the user performs searching by using a terminal device. In this way, inconvenience is brought to the user.

### SUMMARY

In view of the above, an objective of embodiments of the present application is to provide an information query method, a terminal device, a system, and a computer storage medium, which can resolve at least the problem existing in the existing technology.

An embodiment of the present application provides an information query method, including:

collecting multimedia information;

performing feature extraction on the multimedia information from at least one feature dimension, to obtain at least one feature parameter corresponding to the multimedia information in each of the feature dimensions; and

performing querying in a corresponding feature dimension based on the at least one extracted feature parameter, to obtain a corresponding query result in the at least one feature dimension.

An embodiment of the present application provides a terminal device, including:

a collection unit, configured to obtain by collection multimedia information;

a feature extraction unit, configured to perform feature extraction on the multimedia information from at least one feature dimension, to obtain at least one feature parameter corresponding to the multimedia information in each of the feature dimensions; and a query unit, configured to perform querying in a corresponding feature dimension based on the at least one extracted feature parameter, to obtain a corresponding query result in the at least one feature dimension.

An embodiment of the present application provides an information query system, including:

a terminal device, configured to: obtain by collection multimedia information; perform feature extraction on the multimedia information from at least one feature dimension, to obtain at least one feature parameter corresponding to the multimedia information in each of the feature dimensions; and perform querying from a server in a corresponding feature dimension based on the at least one extracted feature parameter, to obtain a corresponding query result in the at least one feature dimension; and

a server, configured to: receive a query from the terminal device; and provide a query result.

An embodiment of the present application further provides a computer storage medium, storing a computer executable instruction, used for: collecting multimedia information; performing feature extraction on the multimedia information from at least one feature dimension, to obtain at least one feature parameter corresponding to the multimedia information in each of the feature dimensions; and performing querying in a corresponding feature dimension based on the at least one extracted feature parameter, to obtain a corresponding query result in the at least one feature dimension.

The information query method, the terminal device, the system, and the computer storage medium provided in the embodiments of the present application can perform feature extraction of at least one feature dimension on the collected multimedia information, so as to acquire a query result in at least one feature dimension. In this way, operation of searching can be made diversified, and operation experience of information searching by a user is improved.

### BRIEF DESCRIPTION OF THE DRAWINGS

FIG. 1 is a schematic flowchart of an information query method according to an embodiment of the present application;

FIG. 2 is a first schematic diagram of an scenario according to an embodiment of the present application;

FIG. 3 is a second schematic diagram of an scenario according to an embodiment of the present application;

FIG. 4 is a third schematic diagram of an scenario according to an embodiment of the present application;

FIG. 5 is a schematic structural diagram of compositions of a terminal device according to an embodiment of the present application;

FIG. 6 is a first schematic structural diagram of compositions of a system according to an embodiment of the present application;

FIG. 7 is a second schematic structural diagram of compositions of a system according to an embodiment of the present application; and

FIG. 8 is a schematic flowchart of compositions of hardware according to an embodiment of the present application.

### DESCRIPTION OF EMBODIMENTS

Implementation of the technical solutions is further described in detail below with reference to the accompanying drawings.

### Embodiment 1

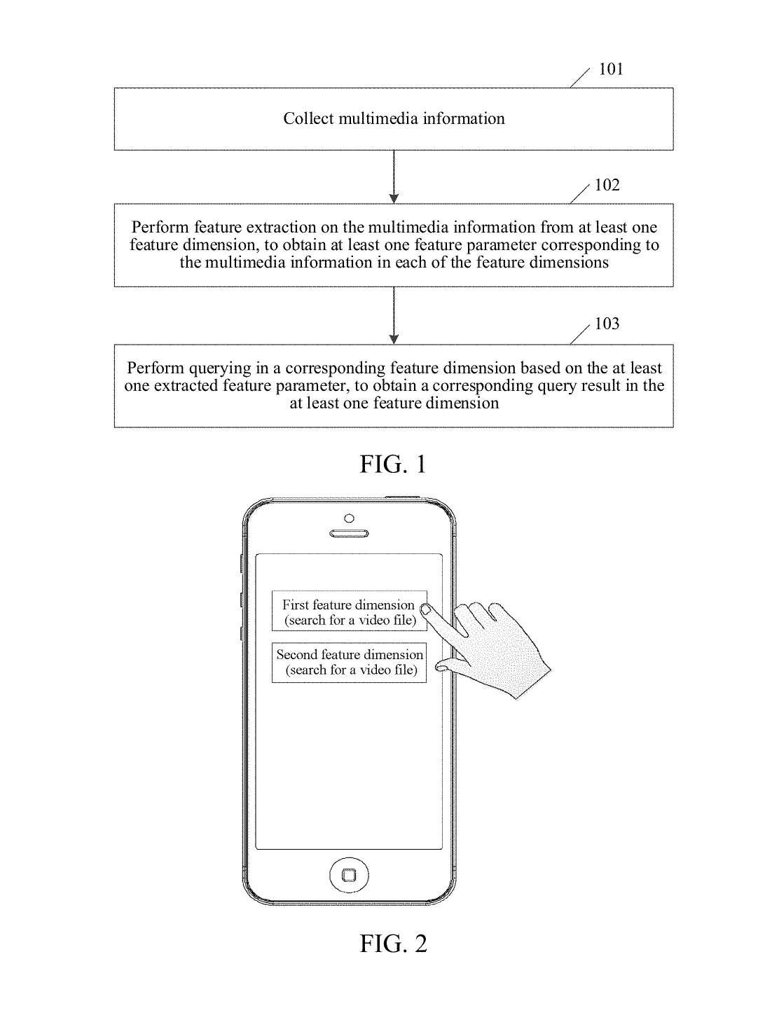

An embodiment of the present application provides an information query method. As shown in FIG. 1, the method includes:

Step 101: Obtain by collection multimedia information.

Step 102: Perform feature extraction on the multimedia information from at least one feature dimension, to obtain at least one feature parameter corresponding to the multimedia information in each of the feature dimensions.

Step 103: Perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

Preferably, before step 102 is performed, the method may further include: determining at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 2

An embodiment of the present application provides an information query method. As shown in FIG. 1, the method includes:

Step 101: Obtain by collection multimedia information.

Step 102: Perform feature extraction on the multimedia information from at least one feature dimension, to obtain at least one feature parameter corresponding to the multimedia information in each of the feature dimensions.

Step 103: Perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

Preferably, before step 102 is performed, the method may further include: determining at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

In step 102 of this embodiment, the operation of performing feature extraction on the multimedia information from at least one feature dimension, to obtain at least one feature parameter corresponding to the multimedia information in each of the feature dimensions may include: selecting at least one target dimension if a type of the multimedia information is audio information; and extracting audio fingerprint feature information from the multimedia information based on the at least one selected target dimension.

The manner of selecting a target dimension may include: displaying at least one feature dimension to a user by using a display screen of a terminal device, and providing a type of an information source to be queried by the at least one feature dimension; and then selecting one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The extracting audio fingerprint feature information from the multimedia information may include: first dividing the multimedia information, that is, audio information, into multiple audio data frames; obtaining by calculation a group of features for each audio data frame; then assembling the calculated features into an eigenvector; performing calculation such as principal component analysis on the obtained eigenvector, to obtain an analyzed eigenvector; and performing quantization on the analyzed eigenvector, to obtain audio fingerprint information. The calculation may be performed in a manner such as a Fast Fourier Transform coefficient, a mel-frequency cepstrum coefficient, or spectral flatness.

Correspondingly, in step 103 of the foregoing embodiment, the operation of performing querying in a corresponding feature dimension based on the at least one extracted feature parameter, to obtain a corresponding query result in the at least one feature dimension may include: performing, based on a first target dimension and the audio fingerprint feature information, querying from an information source corresponding to the first target dimension; and obtaining by querying, from the information source corresponding to the first target dimension, a video file matching the audio fingerprint feature information as a query result.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

In this embodiment, the obtaining by querying, from the information source corresponding to the first target dimension, a video file matching the audio fingerprint feature information as a query result may be specifically: matching Sohu audio fingerprint feature information and at least one piece of the audio fingerprint feature information of video files in the information source, to obtain a matched video file; and displaying identification information of the matched video file on a display screen of the terminal device as a query result.

In this way, by means of the manner, provided in this embodiment, of acquiring a target video file as a query result based on the audio fingerprint feature information, a manner of video file searching can be enhanced, and using experience of a user can be improved.

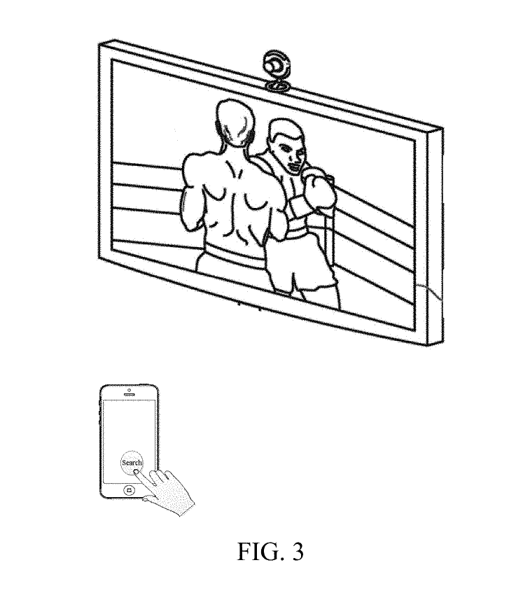

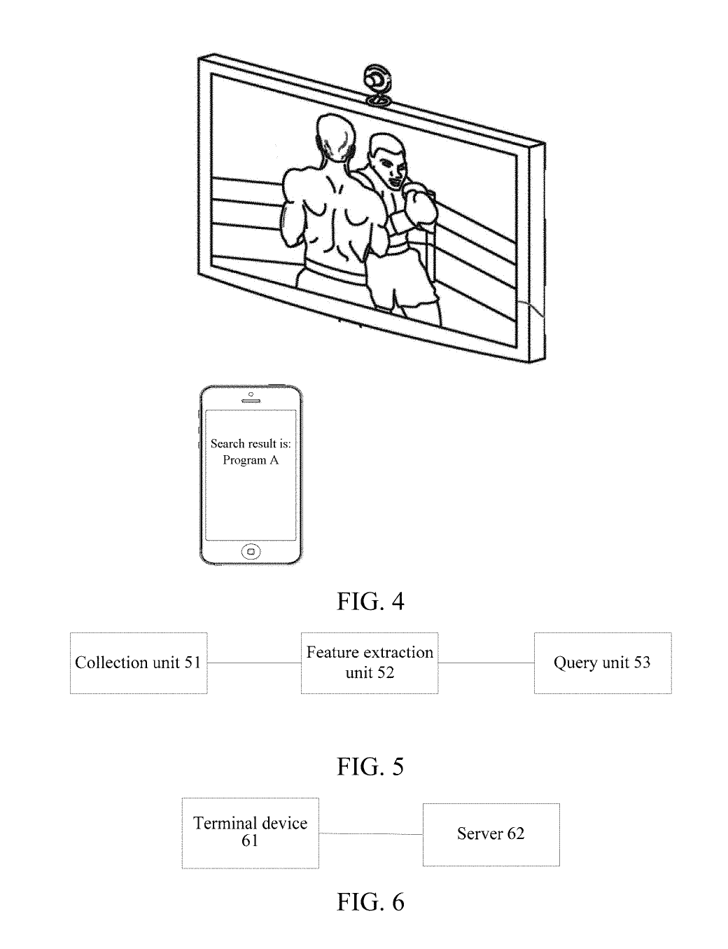

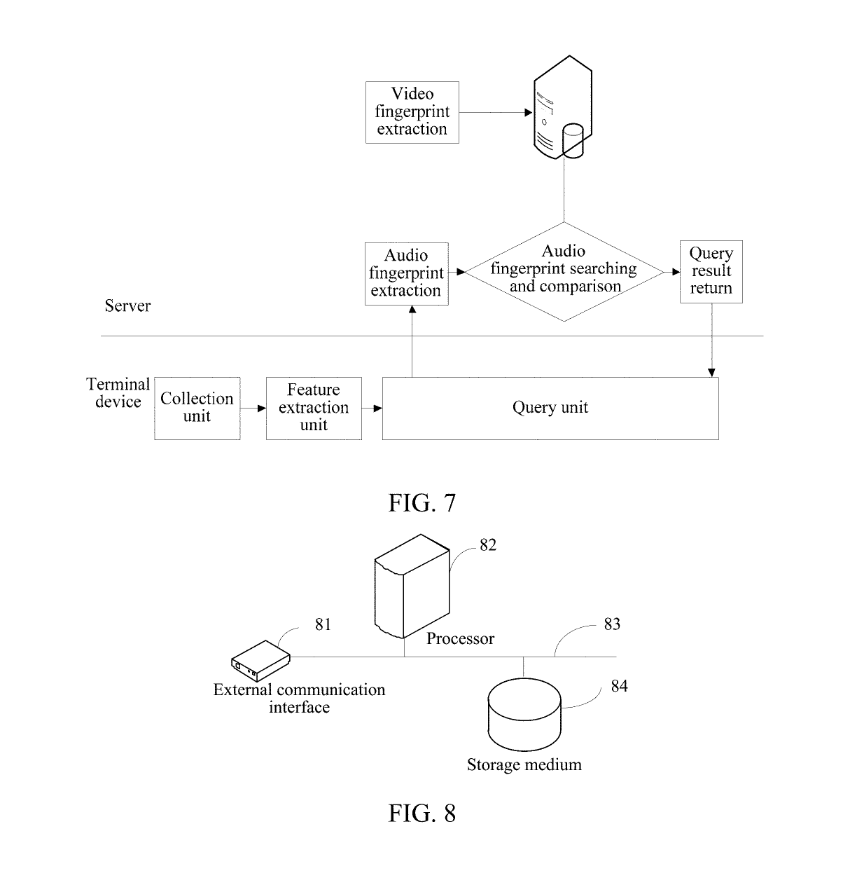

With reference to FIG. 3, scenario description is performed on this embodiment: When a user opens a television, a program is currently playing. When the user needs to know what the program played in the television is, the user clicks on a “search” button on a terminal device, that is, a smartphone. Then the smartphone performs audio collection to obtain audio information, and extracts audio fingerprint feature information from the audio information. Searching is performed in an information source consisting of multiple video files based on the obtained audio fingerprint feature information, and a video file matching the audio fingerprint feature information is selected. Then as shown in FIG. 4, a name of the video file is outputted to the user.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 3

An embodiment of the present application provides an information query method. As shown in FIG. 1, the method includes:

Step 101: Obtain by collection multimedia information.

Step 102: Perform feature extraction on the multimedia information from at least one feature dimension, to obtain at least one feature parameter corresponding to the multimedia information in each of the feature dimensions.

Step 103: Perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

Preferably, before step 102 is performed, the method may further include: determining at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

In step 102 of this embodiment, the operation of performing feature extraction on the multimedia information from at least one feature dimension, to obtain at least one feature parameter corresponding to the multimedia information in each of the feature dimensions may include: selecting a first target dimension from the at least one feature dimension, where the first target dimension indicates that a feature required to be extracted from the multimedia information is audio fingerprint feature information, and a file type in the corresponding information source is a video file; and extracting audio fingerprint feature information from the multimedia information based on the selected first target dimension.

The manner of selecting a first target dimension may include: displaying at least one feature dimension to a user by using a display screen of a terminal device, and providing a type of an information source to be queried by the at least one feature dimension; and then selecting one feature dimension from multiple displayed target dimensions as the first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The extracting audio fingerprint feature information from the multimedia information may include: first dividing the multimedia information, that is, audio information, into multiple audio data frames; obtaining by calculation a group of features for each audio data frame; then assembling the calculated features into an eigenvector; performing calculation such as principal component analysis on the obtained eigenvector, to obtain an analyzed eigenvector; and performing quantization on the analyzed eigenvector, to obtain audio fingerprint information. The calculation may be performed in a manner such as a Fast Fourier Transform coefficient, a mel-frequency cepstrum coefficient, or spectral flatness.

Correspondingly, in step 103 of the foregoing embodiment, the operation of performing querying in a corresponding feature dimension based on the at least one extracted feature parameter, to obtain a corresponding query result in the at least one feature dimension may include: performing querying from an information source based on each of the at least one target dimension and the audio fingerprint feature information, to obtain by querying an audio file matching the audio fingerprint feature information; and acquiring at least one query result related to a target object corresponding to the audio file based on the audio file.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

The target object in this embodiment may be product information corresponding to the audio file, or identification information corresponding to the audio file, or information about a manufacturer corresponding to the audio file.

The acquiring at least one query result related to a target object corresponding to the audio file may include: a singer corresponding to the audio file and other information about the singer.

Alternatively, the acquiring at least one query result related to a target object corresponding to the audio file may include: searching, based on the audio file, in an information source including service information, to obtain at least one piece of the service information of the target object corresponding to the audio file. The service information may include at least one of the following: at least one piece of website link information of the target object, an application identification corresponding to the target object, and an application downlink link corresponding to the target. For example, when audio is collected, the obtained multimedia information is audio information. The audio file is determined based on the audio fingerprint feature information, the audio file is a ring tone of the Apple, and then the target object is an Apple product. A corresponding search result may be a result such as the Apple's official website, an Apple purchase webpage on JD, cell phone configuration information, and Apple's hot software.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 4

An embodiment of the present application provides an information query method. As shown in FIG. 1, the method includes:

Step 101: Obtain by collection multimedia information.

Step 102: Perform feature extraction on the multimedia information from at least one feature dimension, to obtain at least one feature parameter corresponding to the multimedia information in each of the feature dimensions.

Step 103: Perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

Preferably, before step 102 is performed, the method may further include: determining at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

In step 102 of this embodiment, the operation of performing feature extraction on the multimedia information from at least one feature dimension, to obtain at least one feature parameter corresponding to the multimedia information in each of the feature dimensions may include: selecting at least one target dimension if a type of the multimedia information is video information; and extracting audio fingerprint feature information and/or video fingerprint feature information from the multimedia information based on the at least one selected target dimension.

The manner of selecting a target dimension may include: displaying at least one feature dimension to a user by using a display screen of a terminal device, and providing a type of an information source to be queried by the at least one feature dimension; and then selecting one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The extracting audio fingerprint feature information from the multimedia information may include: first dividing the multimedia information, that is, audio information, into multiple audio data frames; obtaining by calculation a group of features for each audio data frame; then assembling the calculated features into an eigenvector; performing calculation such as principal component analysis on the obtained eigenvector, to obtain an analyzed eigenvector; and performing quantization on the analyzed eigenvector, to obtain audio fingerprint information. The calculation may be performed in a manner such as a Fast Fourier Transform coefficient, a mel-frequency cepstrum coefficient, or spectral flatness.

Video fingerprint extraction may perform discrete cosine transform on image frames in a video besides separating audio alone to perform fingerprint extraction, to obtain an energy feature of each image frame as a fingerprint, or use a difference of energy features between image frames as video fingerprint feature information.

Correspondingly, in step 103 of the foregoing embodiment, the operation of performing querying in a corresponding feature dimension based on the at least one extracted feature parameter, to obtain a corresponding query result in the at least one feature dimension may include: performing querying from an information source based on each of the at least one target dimension and the audio fingerprint feature information and/or the video fingerprint feature information, to obtain by querying at least one query result related to a target object corresponding to the audio fingerprint feature information and/or the video fingerprint feature information.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

The target object in this embodiment may be product information corresponding to the audio file, or identification information corresponding to the audio file, or information about a manufacturer corresponding to the audio file.

The acquiring at least one query result related to a target object corresponding to the audio fingerprint feature information may include: a singer corresponding to the audio fingerprint feature information and other information about the singer.

Alternatively, the acquiring at least one query result related to a target object corresponding to the audio fingerprint feature information may include: searching, based on the audio fingerprint feature information, in an information source including service information, to obtain at least one piece of the service information of the target object corresponding to the audio file. The service information may include at least one of the following: at least one piece of website link information of the target object, an application identification corresponding to the target object, and an application downlink link corresponding to the target object. For example, when audio is collected, the obtained multimedia information is audio information. The audio file is determined based on the audio fingerprint feature information, the audio file is a ring tone of the Apple, and then the target object is an Apple product. A corresponding search result may be a result such as the Apple's official website, an Apple purchase webpage on JD, cell phone configuration information, and Apple's hot software.

In addition, in this embodiment, the target object corresponding to the video fingerprint feature information may be one character or one product in a frame of image.

Acquiring the at least one query result related to the target object corresponding to the video fingerprint feature information may be: acquiring information such as a character name corresponding to character feature and character introduction, or information such as a product name corresponding to a product, a product purchase website, and product introduction.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 5

An embodiment of the present application provides a terminal device, as shown in FIG. 5, including:

a collection unit 51, configured to obtain by collection multimedia information;

a feature extraction unit 52, configured to perform feature extraction on the multimedia information from at least one feature dimension, to obtain at least one feature parameter corresponding to the multimedia information in each of the feature dimensions; and a query unit 53, configured to perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

Preferably, the feature extraction unit is further configured to determine at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

The feature extraction unit is configured to: select at least one target dimension if a type of the multimedia information is audio information; and extract audio fingerprint feature information from the multimedia information based on the at least one selected target dimension.

The feature extraction unit is specifically configured to: display at least one feature dimension to a user by using a display screen of a terminal device, and provide a type of an information source to be queried by the at least one feature dimension; and then select one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The feature extraction unit is specifically configured to: first divide the multimedia information, that is, audio information, into multiple audio data frames; obtain by calculation a group of features for each audio data frame; then assemble the calculated features into an eigenvector; perform calculation such as principal component analysis on the obtained eigenvector, to obtain an analyzed eigenvector; and perform quantization on the analyzed eigenvector, to obtain audio fingerprint information. The calculation may be performed in a manner such as a Fast Fourier Transform coefficient, a mel-frequency cepstrum coefficient, or spectral flatness.

Correspondingly, the query unit is configured: to perform, based on a first target dimension and the audio fingerprint feature information, querying from an information source corresponding to the first target dimension; and obtain by querying, from the information source corresponding to the first target dimension, a video file matching the audio fingerprint feature information as a query result.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

In this embodiment, the obtaining by querying, from the information source corresponding to the first target dimension, a video file matching the audio fingerprint feature information as a query result may be specifically: matching Sohu audio fingerprint feature information and at least one piece of the audio fingerprint feature information of video files in the information source, to obtain a matched video file; and displaying identification information of the matched video file on a display screen of the terminal device as a query result.

In this way, by means of the manner, provided in this embodiment, of acquiring a target video file as a query result based on the audio fingerprint feature information, a manner of video file searching can be enhanced, and using experience of a user can be improved.

With reference to FIG. 3, scenario description is performed on this embodiment: When a user opens a television, a program is currently playing. When the user needs to know what the program played in the television is, the user clicks on a “search” button on a terminal device, that is, a smartphone. Then the smartphone performs audio collection to obtain audio information, and extracts audio fingerprint feature information from the audio information. Searching is performed in an information source consisting of multiple video files based on the obtained audio fingerprint feature information, and a video file matching the audio fingerprint feature information is selected. Then as shown in FIG. 4, a name of the video file is outputted to the user.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 6

An embodiment of the present application provides a terminal device, as shown in FIG. 5, including:

a collection unit 51, configured to obtain by collection multimedia information;

a feature extraction unit 52, configured to perform feature extraction on the multimedia information from at least one feature dimension, to obtain at least one feature parameter corresponding to the multimedia information in each of the feature dimensions; and a query unit 53, configured to perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

The feature extraction unit is specifically configured to: select a first target dimension from the at least one feature dimension, where the first target dimension indicates that a feature required to be extracted from the multimedia information is audio fingerprint feature information, and a file type in the corresponding information source is a video file; and extract audio fingerprint feature information from the multimedia information based on the selected first target dimension.

The feature extraction unit is specifically configured to: display at least one feature dimension to a user by using a display screen of a terminal device, and provide a type of an information source to be queried by the at least one feature dimension; and then select one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The feature extraction unit is specifically configured to: first divide the multimedia information, that is, audio information, into multiple audio data frames; obtain by calculation a group of features for each audio data frame; then assemble the calculated features into an eigenvector; perform calculation such as principal component analysis on the obtained eigenvector, to obtain an analyzed eigenvector; and perform quantization on the analyzed eigenvector, to obtain audio fingerprint information. The calculation may be performed in a manner such as a Fast Fourier Transform coefficient, a mel-frequency cepstrum coefficient, or spectral flatness.

Correspondingly, the query unit is configured to: perform querying from an information source based on each of the at least one target dimension and the audio fingerprint feature information, to obtain by querying an audio file matching the audio fingerprint feature information; and acquire at least one query result related to a target object corresponding to the audio file based on the audio file.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

The target object in this embodiment may be product information corresponding to the audio file, or identification information corresponding to the audio file, or information about a manufacturer corresponding to the audio file.

The acquiring at least one query result related to a target object corresponding to the audio file may include: a singer corresponding to the audio file and other information about the singer.

Alternatively, the acquiring at least one query result related to a target object corresponding to the audio file may include: searching, based on the audio file, in an information source including service information, to obtain at least one piece of the service information of the target object corresponding to the audio file. The service information may include at least one of the following: at least one piece of website link information of the target object, an application identification corresponding to the target object, and an application downlink link corresponding to the target. For example, when audio is collected, the obtained multimedia information is audio information. The audio file is determined based on the audio fingerprint feature information, the audio file is a ring tone of the Apple, and then the target object is an Apple product. A corresponding search result may be a result such as the Apple's official website, an Apple purchase webpage on JD, cell phone configuration information, and Apple's hot software.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 7

An embodiment of the present application provides a terminal device, as shown in FIG. 5, including:

a collection unit 51, configured to obtain by collection multimedia information;

a feature extraction unit 52, configured to perform feature extraction on the multimedia information from at least one feature dimension, to obtain at least one feature parameter corresponding to the multimedia information in each of the feature dimensions; and a query unit 53, configured to perform querying in a corresponding feature dimension based on the at least one extracted feature parameter, to obtain a corresponding query result in the at least one feature dimension.

Here, the multimedia information may be any one of the following types: audio information, video information, and image information.

The feature dimension may consist of the following elements: at least one feature information required for searching, and a corresponding information source.

Preferably, the feature extraction unit 52 is further configured to determine at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

The feature extraction unit 52 of this embodiment is configured to: select at least one target dimension if a type of the multimedia information is video information; and extract audio fingerprint feature information and/or video fingerprint feature information from the multimedia information based on the at least one selected target dimension.

The feature extraction unit 52 is configured to: display at least one feature dimension to a user by using a display screen of a terminal device, and provide a type of an information source to be queried by the at least one feature dimension; and then select one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The feature extraction unit 52 is configured to: first divide the multimedia information, that is, audio information, into multiple audio data frames; obtain by calculation a group of features for each audio data frame; then assemble the calculated features into an eigenvector; perform calculation such as principal component analysis on the obtained eigenvector, to obtain an analyzed eigenvector; and perform quantization on the analyzed eigenvector, to obtain audio fingerprint information. The calculation may be performed in a manner such as a Fast Fourier Transform coefficient, a mel-frequency cepstrum coefficient, or spectral flatness.

The feature extraction unit 52 is configured to perform discrete cosine transform on image frames in a video besides separating audio alone to perform fingerprint extraction, to obtain an energy feature of each image frame as a fingerprint, or use a difference of energy features between image frames as video fingerprint feature information.

Correspondingly, the query unit is configured to perform querying from an information source based on each of the at least one target dimension and the audio fingerprint feature information and/or the video fingerprint feature information, to obtain by querying at least one query result related to a target object corresponding to the audio fingerprint feature information and/or the video fingerprint feature information.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

The target object in this embodiment may be product information corresponding to the audio file, or identification information corresponding to the audio file, or information about a manufacturer corresponding to the audio file.

The query unit is configured to query a singer corresponding to the audio fingerprint feature information and other information about the singer.

Alternatively, the query unit is configured to search, based on the audio fingerprint feature information, in an information source including service information, to obtain at least one piece of the service information of the target object corresponding to the audio file. The service information may include at least one of the following: at least one piece of website link information of the target object, an application identification corresponding to the target object, and an application downlink link corresponding to the target object. For example, when audio is collected, the obtained multimedia information is audio information. The audio file is determined based on the audio fingerprint feature information, the audio file is a ring tone of the Apple, and then the target object is an Apple product. A corresponding search result may be a result such as the Apple's official website, an Apple purchase webpage on JD, cell phone configuration information, and Apple's hot software.

In addition, in this embodiment, the target object corresponding to the video fingerprint feature information may be one character or one product in a frame of image.

Acquiring the at least one query result related to the target object corresponding to the video fingerprint feature information may be: acquiring information such as a character name corresponding to character feature and character introduction, or information such as a product name corresponding to a product, a product purchase website, and product introduction.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 8

An embodiment of the present application provides an information query system. As shown in FIG. 6, the system includes:

a terminal device 61, configured to: obtain by collection multimedia information; perform feature extraction on the multimedia information from at least one feature dimension, to obtain at least one feature parameter corresponding to the multimedia information in each of the feature dimensions; and perform querying from a server in a corresponding feature dimension based on the at least one extracted feature parameter, to obtain a corresponding query result in the at least one feature dimension; and

a server 62, configured to: receive the information query from the terminal device; and provide a query result.

Here, the multimedia information may be any one of the following types: audio information, video information, and image information.

The feature dimension may consist of the following elements: at least one feature information required for searching, and a corresponding information source.

Preferably, the terminal device 61 is further configured to determine at least one feature dimension based on a type of the multimedia information. As noted above, the terminal device 61 can be a smartphone having a camera for capturing video signals of a program played on a television and a microphone for capturing audio signals of the program. Using the captured video and/or audio signals, a user of the terminal device 61 can find other information related to the program, e.g., the program's genre, cast, rating, broadcasting schedule as well as other programs deemed as being similar to the program by the server.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

The terminal device is configured to: select at least one target dimension if a type of the multimedia information is audio information; and extract audio fingerprint feature information from the multimedia information based on the at least one selected target dimension.

The feature extraction unit is specifically configured to: display at least one feature dimension to a user by using a display screen of a terminal device, and provide a type of an information source to be queried by the at least one feature dimension; and then select one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The terminal device is configured to: first divide the multimedia information, that is, audio information, into multiple audio data frames; obtain by calculation a group of features for each audio data frame; then assemble the calculated features into an eigenvector; perform calculation such as principal component analysis on the obtained eigenvector, to obtain an analyzed eigenvector; and perform quantization on the analyzed eigenvector, to obtain audio fingerprint information. The calculation may be performed in a manner such as a Fast Fourier Transform coefficient, a mel-frequency cepstrum coefficient, or spectral flatness.

Correspondingly, the terminal device is configured: to perform, based on a first target dimension and the audio fingerprint feature information, querying from an information source corresponding to the first target dimension; and obtain by querying, from the information source corresponding to the first target dimension, a video file matching the audio fingerprint feature information as a query result.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

In this embodiment, the obtaining by querying, from the information source corresponding to the first target dimension, a video file matching the audio fingerprint feature information as a query result may be specifically: matching Sohu audio fingerprint feature information and at least one piece of the audio fingerprint feature information of video files in the information source, to obtain a matched video file; and displaying identification information of the matched video file on a display screen of the terminal device as a query result.

In this way, by means of the manner, provided in this embodiment, of acquiring a target video file as a query result based on the audio fingerprint feature information, a manner of video file searching can be enhanced, and using experience of a user can be improved.

With reference to FIG. 3, scenario description is performed on this embodiment: When a user opens a television, a program is currently playing. When the user needs to know what the program played in the television is, the user clicks on a “search” button on a terminal device, that is, a smartphone. Then the smartphone performs audio collection to obtain audio information, and extracts audio fingerprint feature information from the audio information. Searching is performed in an information source consisting of multiple video files based on the obtained audio fingerprint feature information, and a video file matching the audio fingerprint feature information is selected. Then as shown in FIG. 4, a name of the video file is outputted to the user.

Preferably, the video file in the information sources of this embodiment may include: a video file, identification information of the video file, and at least one piece of the audio fingerprint feature information of the video file.

The target object in this embodiment may be product information corresponding to the audio file, or identification information corresponding to the audio file, or information about a manufacturer corresponding to the audio file.

The acquiring at least one query result related to a target object corresponding to the audio file may include: a singer corresponding to the audio file and other information about the singer.

Alternatively, the acquiring at least one query result related to a target object corresponding to the audio file may include: searching, based on the audio file, in an information source including service information, to obtain at least one piece of the service information of the target object corresponding to the audio file. The service information may include at least one of the following: at least one piece of website link information of the target object, an application identification corresponding to the target object, and an application downlink link corresponding to the target. For example, when audio is collected, the obtained multimedia information is audio information. The audio file is determined based on the audio fingerprint feature information, the audio file is a ring tone of the Apple, and then the target object is an Apple product. A corresponding search result may be a result such as the Apple's official website, an Apple purchase webpage on JD, cell phone configuration information, and Apple's hot software.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

### Embodiment 9

An embodiment of the present application provides an information query system. As shown in FIG. 6, the system includes:

a terminal device 61, configured to: obtain by collection multimedia information; perform feature extraction on the multimedia information from at least one feature dimension, to obtain at least one feature parameter corresponding to the multimedia information in each of the feature dimensions; and perform querying from a server in a corresponding feature dimension based on the at least one extracted feature parameter, to obtain a corresponding query result in the at least one feature dimension; and a server 62, configured to: receive the information query from the terminal device; and provide a query result.

Here, the multimedia information may be any one of the following types: audio information, video information, and image information.

The feature dimension may consist of the following elements: at least one feature information required for searching, and a corresponding information source.

Preferably, the feature extraction unit 42 is further configured to determine at least one feature dimension based on a type of the multimedia information.

For example, if the multimedia information is video information, the feature dimension can be determined as: audio fingerprint feature information, and feature information in an image frame need to be acquired, and then an information type of the corresponding information source is a video file.

Alternatively, if the multimedia information is audio information, the feature dimension can be determined to include following several ones: a first feature dimension is: audio fingerprint feature information needs to be acquired, and a type of the corresponding information source is an audio file; a second feature dimension is: audio fingerprint feature information needs to be acquired, and a type of the corresponding information source is a video file; a third feature dimension is: audio fingerprint feature information needs to be acquired, and a type of a corresponding information source includes an audio file and a video file.

The feature extraction unit 42 of this embodiment is configured to: select at least one target dimension if a type of the multimedia information is video information; and extract audio fingerprint feature information and/or video fingerprint feature information from the multimedia information based on the at least one selected target dimension.

The feature extraction unit 42 is configured to: display at least one feature dimension to a user by using a display screen of a terminal device, and provide a type of an information source to be queried by the at least one feature dimension; and then select one feature dimension from multiple displayed target dimensions as a first target dimension. For example, as shown in FIG. 2, two feature dimensions, which are separately the first feature dimension and the second feature dimension, are displayed to the user. Then selection is performed according to different information types of the first feature dimension and the second feature dimension. It can be understood that FIG. 2 provided in this embodiment is merely schematic. In practice, the feature dimension can be displayed to the user by using different manners. In addition, the feature dimension may not be displayed, and the user may be merely prompted to “search for music” or “search for videos”. In this way, convenience of user using can be further improved.

The audio fingerprint feature may be feature information identifying the multimedia information.

The feature extraction unit 42 is configured to: first divide the multimedia information, that is, audio information, into multiple audio data frames; obtain by calculation a group of features for each audio data frame; then assemble the calculated features into an eigenvector; perform calculation such as principal component analysis on the obtained eigenvector, to obtain an analyzed eigenvector; and perform quantization on the analyzed eigenvector, to obtain audio fingerprint information. The calculation may be performed in a manner such as a Fast Fourier Transform coefficient, a mel-frequency cepstrum coefficient, or spectral flatness.

The feature extraction unit 42 is configured to perform discrete cosine transform on image frames in a video besides separating audio alone to perform fingerprint extraction, to obtain an energy feature of each image frame as a fingerprint, or use a difference of energy features between image frames as video fingerprint feature information.

Correspondingly, the query unit is configured to perform querying from an information source based on each of the at least one target dimension and the audio fingerprint feature information and/or the video fingerprint feature information, to obtain by querying at least one query result related to a target object corresponding to the audio fingerprint feature information and/or the video fingerprint feature information.

Manners of the querying in this embodiment may include following several ones:

Manner 1: All files of a video type stored in a terminal device are used as a first information source, and querying is performed in the first information source, to obtain a video file matching the audio fingerprint feature information as a query result.

Manner 2: All files of a video type stored at a server side are used as a second information source, and querying is performed in the second information source, to obtain a video file matching the audio fingerprint feature information as a query result.

Manner 3: All files of a video type stored in a terminal device are used as a first information source, and all files of a video type stored at a server side are used as a second information source.

First, querying is performed in the first information source. If a video file matching the audio fingerprint feature information is queried, the video file is used as a query result.

If a matching video file is queried, querying is performed in the second information source, to obtain a video file matching the audio fingerprint feature information as a query result.

Preferably, the video file in the information sources of this embodiment may include: a video file, identification information of the video file, and at least one piece of the audio fingerprint feature information of the video file.

The target object in this embodiment may be product information corresponding to the audio file, or identification information corresponding to the audio file, or information about a manufacturer corresponding to the audio file.

The query unit is configured in a singer corresponding to the audio fingerprint feature information and other information about the singer.

Alternatively, the query unit is configured to search, based on the audio fingerprint feature information, in an information source including service information, to obtain at least one piece of the service information of the target object corresponding to the audio file. The service information may include at least one of the following: at least one piece of website link information of the target object, an application identification corresponding to the target object, and an application downlink link corresponding to the target object. For example, when audio is collected, the obtained multimedia information is audio information. The audio file is determined based on the audio fingerprint feature information, the audio file is a ring tone of the Apple, and then the target object is an Apple product. A corresponding search result may be a result such as the Apple's official website, an Apple purchase webpage on JD, cell phone configuration information, and Apple's hot software.

In addition, in this embodiment, the target object corresponding to the video fingerprint feature information may be one character or one product in a frame of image.

Acquiring the at least one query result related to the target object corresponding to the video fingerprint feature information may be: acquiring information such as a character name corresponding to character feature and character introduction, or information such as a product name corresponding to a product, a product purchase website, and product introduction.

An example of performing operation by combining units of the system in this embodiment is shown in FIG. 8. First, a terminal device collects multimedia information based on a collection unit, and then performs audio fingerprint feature extraction or video feature extraction from a feature extraction unit, and a query unit performs sending to a server.

A server side acquires an audio fingerprint from the query unit, then searches for a video fingerprint to obtain a query result, returns the query result to the query unit of the terminal device, and then displays the query result to a user.

Alternatively, the server extracts a video fingerprint and also performs searching to obtain a query result and returns the query result to the query unit of the terminal device.

It can be seen that by means of the foregoing solutions, feature extraction of at least one feature dimension can be performed on the collected multimedia information, so as to acquire a query result in at least one feature dimension. In this way, operation of searching can be made diversified, and operation experience of information searching by a user is improved.

In several embodiments provided in this application, it should be understood that the disclosed device and method can be implemented in other manners. The above-described device embodiments are merely schematic. For example, division of the units is merely division of logic functions and may be another division manner during actual implementation. For example, multiple units or components may be combined or may be integrated into another system, or some features may be omitted or not be executed. In addition, mutual coupling, direct coupling, or communication connection between the displayed or discussed constituent parts may be indirect coupling or communication connection by means of some interfaces, devices, or units and may be electric, mechanical, or of another form.

The foregoing units described as separate components may be or may not be physically separated. Components displayed as units may be or may not be physical units, and may be located in one place or may be distributed on multiple network units. An objective of the solutions of this embodiment may be implemented by selecting some or all of the units according to actual needs.

In addition, the functional modules in the embodiments of the present application may be integrated into one processing unit, or each of the units may be used a unit alone, or two or more units may be integrated into one unit. The integrated units may be implemented in the form of hardware, or may be implemented in the form of a hardware and software functional unit.

A person of ordinary skill in the art may understand that all or some of the steps of the foregoing method embodiments may be implemented by using hardware relevant to a program instruction. The program may be stored in a computer readable storage medium. When being executed, the program executes steps of the foregoing method embodiments. The storage medium includes: various media capable of storing program code such as a mobile storage device, a read-only memory (ROM, Read-Only Memory), a random access memory (RAM, Random Access Memory), a magnetic disk, or an optical disc.

This embodiment provides specific hardware based on the foregoing device embodiments. As shown in FIG. 8, the apparatus includes a processor 82, a storage medium 84, and at least one external communication interface 81. The processor 82, the storage medium 84, and the external communication interface 81 are all connected by using a bus 83. The processor 82 may be an electronic part and component with a processing function such as a microprocessor, a central processing unit, a digital signal processor, or a programmable logic array. Computer executable code is stored in the storage medium.

The hardware may be the server. When executing the computer executable code, the processor can implement at least the following functions: collecting multimedia information; performing feature extraction on the multimedia information from at least one feature dimension, to obtain at least one feature parameter corresponding to the multimedia information in each of the feature dimensions; and performing querying in a corresponding feature dimension based on the at least one extracted feature parameter, to obtain a corresponding query result in the at least one feature dimension.

The foregoing descriptions are merely specific implementation manners of the present application, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

What is claimed is:

1. An information query method performed at a terminal device having one or more processors and memory for storing a plurality of programs to be executed by the one or more processors, wherein the terminal device is communicatively coupled to a server that has access an information database, the method comprising:
collecting multimedia information using the terminal device;
performing feature extraction on the multimedia information from at least one feature dimension, to obtain at least one feature parameter corresponding to the multimedia information in each of the feature dimensions;
performing querying in a corresponding feature dimension based on the at least one extracted feature parameter to obtain a corresponding query result in the at least one feature dimension by submitting a search request including information of the at least one extracted feature parameter to the server, wherein the server is configured to generate the corresponding query result from the information database using the at least one feature parameter and return the corresponding query result to the terminal device; and
receiving and displaying the corresponding query result using the terminal device.

2. The method according to claim 1, wherein the operation of performing feature extraction on the multimedia information from at least one feature dimension, to obtain at least one feature parameter corresponding to the multimedia information in each of the feature dimensions comprises:
selecting at least one target dimension if a type of the multimedia information is audio information; and
extracting audio fingerprint feature information from the multimedia information based on the at least one selected target dimension.

3. The method according to claim 2, wherein the operation of performing querying in a corresponding feature dimension based on the at least one extracted feature parameter, to obtain a corresponding query result in the at least one feature dimension comprises:
performing, based on a first target dimension and the audio fingerprint feature information, querying from an information source in the information database corresponding to the first target dimension; and
obtaining by querying, from the information source corresponding to the first target dimension, a video file matching the audio fingerprint feature information as the corresponding query result.

4. The method according to claim 2, wherein the operation of performing querying in a corresponding feature dimension based on the at least one extracted feature parameter, to obtain a corresponding query result in the at least one feature dimension comprises:
performing querying from an information source based on each of the at least one target dimension and the audio fingerprint feature information, to obtain by querying at least one query result related to a target object corresponding to the audio fingerprint feature information.

5. The method according to claim 1, wherein the operation of performing feature extraction on the multimedia information from at least one feature dimension, to obtain at least one feature parameter corresponding to the multimedia information in each of the feature dimensions comprises:
selecting at least one target dimension if a type of the multimedia information is video information; and
extracting audio fingerprint feature information and/or video fingerprint feature information from the multimedia information based on the at least one selected target dimension.

6. The method according to claim 5, wherein the operation of performing querying in a corresponding feature dimension based on the at least one extracted feature parameter, to obtain a corresponding query result in the at least one feature dimension comprises:
performing querying from an information source based on each of the at least one target dimension and the audio fingerprint feature information and/or the video fingerprint feature information, to obtain by querying at least one query result related to a target object corresponding to the audio fingerprint feature information and/or the video fingerprint feature information.

7. A terminal device, wherein the terminal device is communicatively coupled to a server that has access an information database, the terminal device comprising:
one or more processors;
memory; and
a plurality of programs stored in the memory, wherein the programs, when executed by the one or more processors, cause the terminal device to perform a plurality of operations including:
collecting multimedia information using the terminal device;
performing feature extraction on the multimedia information from at least one feature dimension, to obtain at least one feature parameter corresponding to the multimedia information in each of the feature dimensions;
performing querying in a corresponding feature dimension based on the at least one extracted feature parameter to obtain a corresponding query result in the at least one feature dimension by submitting a search request including information of the at least one extracted feature parameter to the server, wherein the server is configured to generate the corresponding query result from the information database using the at least one feature parameter and return the corresponding query result to the terminal device; and
receiving and displaying the corresponding query result using the terminal device.

8. The terminal device according to claim 7, wherein the operation of performing feature extraction on the multimedia information from at least one feature dimension, to obtain at least one feature parameter corresponding to the multimedia information in each of the feature dimensions comprises:
selecting at least one target dimension if a type of the multimedia information is audio information; and
extracting audio fingerprint feature information from the multimedia information based on the at least one selected target dimension.

9. The terminal device according to claim 8, wherein the operation of performing querying in a corresponding feature dimension based on the at least one extracted feature parameter, to obtain a corresponding query result in the at least one feature dimension comprises:
performing, based on a first target dimension and the audio fingerprint feature information, querying from an information source in the information database corresponding to the first target dimension; and
obtaining by querying, from the information source corresponding to the first target dimension, a video file matching the audio fingerprint feature information as the corresponding query result.

10. The terminal device according to claim 8, wherein the operation of performing querying in a corresponding feature dimension based on the at least one extracted feature parameter, to obtain a corresponding query result in the at least one feature dimension comprises:
performing querying from an information source based on each of the at least one target dimension and the audio fingerprint feature information, to obtain by querying at least one query result related to a target object corresponding to the audio fingerprint feature information.

11. The terminal device according to claim 7, wherein the operation of performing feature extraction on the multimedia information from at least one feature dimension, to obtain at least one feature parameter corresponding to the multimedia information in each of the feature dimensions comprises:
selecting at least one target dimension if a type of the multimedia information is video information; and
extracting audio fingerprint feature information and/or video fingerprint feature information from the multimedia information based on the at least one selected target dimension.

12. The terminal device according to claim 11, wherein the operation of performing querying in a corresponding feature dimension based on the at least one extracted feature parameter, to obtain a corresponding query result in the at least one feature dimension comprises:
performing querying from an information source based on each of the at least one target dimension and the audio fingerprint feature information and/or the video fingerprint feature information, to obtain by querying at least one query result related to a target object corresponding to the audio fingerprint feature information and/or the video fingerprint feature information.

13. A non-transitory computer storage medium, storing a plurality of programs, in connection with a terminal device having one or more processors, wherein the terminal device is communicatively coupled to a server that has access an information database, the plurality of programs including instructions for:
collecting multimedia information using the terminal device;
performing feature extraction on the multimedia information from at least one feature dimension, to obtain at least one feature parameter corresponding to the multimedia information in each of the feature dimensions;
performing querying in a corresponding feature dimension based on the at least one extracted feature parameter to obtain a corresponding query result in the at least one feature dimension by submitting a search request including information of the at least one extracted feature parameter to the server, wherein the server is configured to generate the corresponding query result from the information database using the at least one feature parameter and return the corresponding query result to the terminal device; and
receiving and displaying the corresponding query result using the terminal device.
